(19) United States
(12) Patent Application Publication
(10) Pub. No.: US 2010/0031242 A1
(43) Pub. Date: Feb. 4, 2010

(54) METHOD AND APPARATUS FOR PROVISIONING A NODE WITH EXECUTABLE CODE

(75) Inventors: Seung Ki Hong, Daejeon (KR); Yeon Jun Choi, Daejeon (KR); Yang Yu, San Jose, CA (US); Loren J. Rittle, Chicago, IL (US); Shin-Young Park, Seoul (KR); Cheol Sik Pyo, Daejeon (KR)

Correspondence Address: MOTOROLA, INC., 1303 EAST ALGONQUIN ROAD, IL01/3RD, SCHAUMBURG, IL, 60196, US

(73) Assignees: MOTOROLA, INC., Schaumburg, IL (US); Electronics and Telecommunications Research Institute (ETRI), Daejeon (KR)

(21) Appl. No.: 12/183,234

(22) Filed: Jul. 31, 2008

(51) Int. Cl. G06F 9/44

(52) U.S. Cl. 717/157

(57) ABSTRACT

A method and apparatus for provisioning a node with executable code is provided herein. Prior to sending out a code request, a node (101) determines a set of nodes that may potentially host the requested code and sends the request to these nodes instead of a blind broadcast. The determination of what nodes have access to the required code is based on a history information of code request of the node, the overhead traffic, and/or application dependencies that are available to the node. The code request is unicast-based and may involve a multi-hop path for both code requests and responses. If this step fails, a broadcast-based approach can be again employed to request the code.

### FIELD OF THE INVENTION

This invention relates generally to wireless sensor nodes and more particularly to the provisioning of executable code.

### BACKGROUND OF THE INVENTION

Various wireless sensor nodes are known in the art. Such wireless sensor nodes often comprise programmable software-based platforms. In some cases, though programmable, such platforms may comprise dedicated-purpose platforms and hence remain essentially unaltered over the course of a usable operational life. In many other cases, however, such platforms are updated from time to time as an expected and normal operational event. An example of the latter comprises Mate virtual machine-based platforms that support a relatively small executable environment having, for example, four loading points to receive corresponding discrete software programs on a relatively dynamic basis. Another example comprises Deluge native code platforms that support a relatively large executable (with respects to the entire memory resources of a node) having the ability to receive a discrete software program while another discrete software program is actively operating. In the case of Deluge, once a discrete software program is activated, it deactivates the other discrete software program. Although the activation signal requires time to propagate, all nodes attempt to activate the same discrete software program. Such platforms have use, for example, in conjunction with ad hoc wireless sensing node networks.

Such wireless sensor nodes are often physically distributed with respect to one another. For example, a plurality of wireless sensor nodes may be distributed throughout a building to monitor various environmental circumstances of interest (such as temperature, humidity, proximal human activity, noise, motion, and essentially any other condition that might occur proximal to such a sensor). In some cases these various wireless sensor nodes may be tasked differently from one another. For example, some wireless sensor nodes may be tasked with measuring temperature while other wireless sensor nodes might be tasked only with measuring local noise conditions. It is also possible that such tasking assignments will change dynamically over time.

Many such network elements, however, comprise relatively resource-poor operational platforms. Significant limitations may exist, for example, with respect to available memory, computational capacity, computational scheduling, power resources, power consumption (including power consumption scheduling), multi-tasking capabilities, peripherals management, and so forth. In a typical deployment it is also likely that multi-hop data conveyance paths will be necessary to move data or executable code from a given wireless sensor node to a corresponding data collection point.

Network configurations and protocols are known that attempt to meet such re-programming needs in a manner that accommodates such limitations. The so-called trickle mode of operation represents one such example (see, for example “Trickle: A Self-Regulating Algorithm for Code Propagation and Maintenance in Wireless Sensor Networks” by Levis, et al. as appears in the March 2004 publication USENIX/ACM Symposium on Networked Systems Design and Implementation). Pursuant to the trickle mode of operation a wireless sensor node is able to share its executable code programming with another wireless sensor node that does not already have such programming (as such, the programming may be viewed as trickling from an initial source through the wireless sensor node network until all of the wireless sensor nodes have received the new programming). This trickle mode of operation is typically used in settings where each and every sensor node within a given network is to be identically programmed.

Unfortunately, such prior art solutions are not wholly adequate for all application settings. For example, as noted above, it is possible for different wireless sensor nodes in a given network to be tasked in different ways. As a result, different wireless sensor nodes can be expected to have different executable code programming needs and resources. Existing solutions are poorly suited to ensure that executable code requirements are met in an efficient manner that is sensitive and accommodating to the many needs and requirements of a typical wireless sensor node network. Therefore, a need exists for a method and apparatus for provisioning a node with executable code that alleviates the above-mentioned issues.

### BRIEF DESCRIPTION OF THE DRAWINGS

FIG. 1 is a block diagram illustrating a wireless sensor network.

FIG. 2 is a block diagram of a node of FIG. 1.

FIG. 3 a logic flow diagram showing operation of the node of FIG. 2 while storing information about nodes.

FIG. 4 is a flow chart showing operation of the node of FIG. 2 when the node needs to obtain executable code.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for provisioning a node with executable code is provided herein. In accordance with the present invention, before sending out a code request, a node determines a set of nodes that may potentially host the requested code and sends the request to these nodes instead of a blind broadcast. The determination of which nodes have access to the required code is based on a history information of code request of the node, the overhead traffic, and/or application dependencies that are available to the node. The code request is unicast-based and may involve a multi-hop path for both code requests and responses. If this step fails, a broadcast-based approach can be again employed to request the code.

The above-described scheme can be used to avoid brute-force flooding by utilizing history information and explore certain nodes using unicast-based communication, before a worst-case flooding is initiated. This potentially can save significant network traffic in both request and code transmission.

The present invention encompasses a method for provisioning a node with executable code. The method comprises the steps of determining if the executable code resides in memory, determining a node having a high probability of having the code, and transmitting a wireless unicast message to the node having the high probability of having the code. The executable code is then received from the node.

The present invention additionally encompasses a method for provisioning a node with executable code. The method comprises the steps of determining that executable code does not reside in a local memory, determining at least one node having a high probability of having the code, and transmitting a wireless unicast message to the at least one node having the high probability of having the code. The wireless unicast message requests the code from the nodes. A determination is then made if the executable code has been received from the at least one node and if the executable code has not been received, then a broadcast message is transmitted requesting the executable code.

The present invention additionally encompasses an apparatus comprising memory storing information as to which nodes have a high probability of having particular code, logic circuitry determining if the executable code resides in memory, and a transmitter transmitting a wireless unicast message to the node having the high probability of having the code.

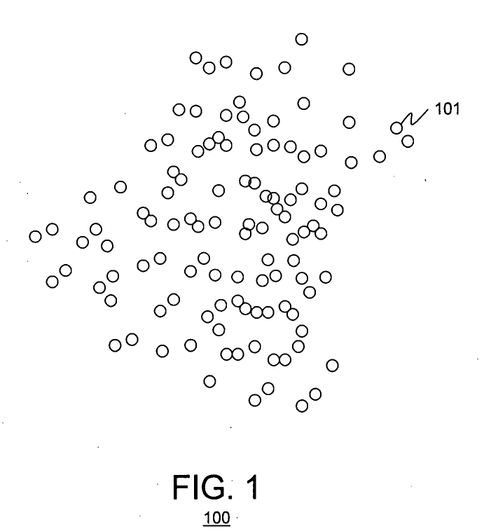

Turning now to the drawings, where like numerals designate like components, FIG. 1 is a block diagram showing an ad-hoc communication system. Communication system 100 preferably utilizes an ad-hoc communication system protocol defined by 802.15.3 Wireless Personal Area Networks for High Data Rates or IEEE 802.15.4 Low Rate Wireless Personal Area Networks. However one of ordinary skill in the art will recognize that other communication system protocols may be utilized without varying from the scope of the invention. For example, communication system 100 may utilize communication system protocols such as, but not limited to, Ad-hoc On Demand Distance Vector Routing (AODV), Dynamic Source Routing (DSR), Temporally-Ordered Routing Algorithm (TORA), Bluetooth™ standard (IEEE Standard 802.15.1), . . . , etc. As shown, communication system 100 includes a number of nodes 101 (only one labeled in FIG. 1). Nodes 101 represent devices that communicate with each other through low-power, short range communication. Nodes 101 can be transportable (mobile) or they can be fixed in a given place.

As one of ordinary skill in the art will recognize, transmissions between two nodes 101 within communication system 100 generally take place through intervening nodes, with the intervening nodes receiving a source transmission, and repeating, or relaying the source transmission until the source transmission reaches its destination node. Thus, a first node, wishing to transmit information to a second node located outside the transmission range of the first node, will have its transmissions pass through intervening nodes.

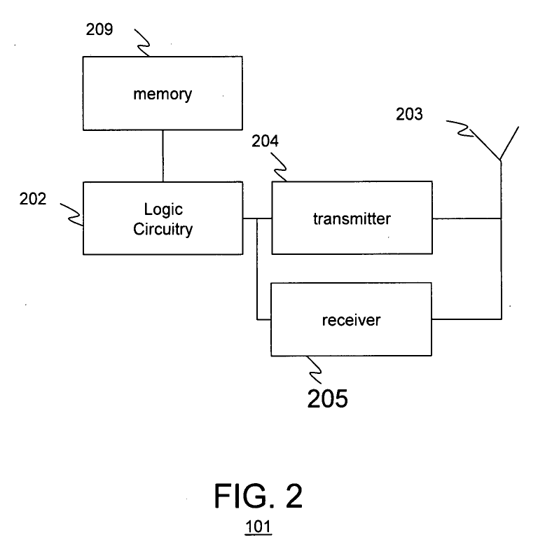

FIG. 2 is a block diagram of node 101. Node 101 comprises antenna 203 coupled to transmitter 204 and receiver 205, in turn, coupled to logic circuitry 202. Database 201 is provided to store executable code along with information regarding which node in communication system 100 has access to a particular program. Although various forms for antenna 203, transmitter 204 and receiver 205, and logic circuitry 202 are envisioned, in one possible embodiment, node 101 is formed from a Freescale Inc. MC13192 transceiver (transmitter 204 and receiver 205) coupled to a Motorola HC08 8-bit processor 202.

As discussed above, node 101 may request, respond to requests for, and/or maintain executable code. In responding to a request for executable code, node 101 will access database 201 to determine if the code resides in memory, an then provide the code to the requesting node if resident in memory. In a typical deployment this executable code will comprise operating instructions that cause or enable the wireless sensor node to carry out one or more of its assigned tasks. As one illustrative example in this regard, this executable code might comprise the instructions that cause a given wireless sensor node to awaken at particular intervals, take an ambient temperature reading, and store that reading pending subsequent use or transmission of that data.

In order to prevent message flooding of communication system 100, before sending out a code request, logic circuitry 202 determines a set of nodes that may potentially host the requested code and sends the request to these nodes instead of a blind broadcast. The speculation is carried out based on a history information of code request of the node, the overhead traffic, and/or application dependencies that are available to the node. The code request is unicast-based and may involve a multi-hop path for both code requests and responses. If this step fails, a broadcast-based approach can be again employed to request the code. One such broadcast-based approach is provided in US2007/0236345A1, WIRELESS SENSOR NODE EXECUTABLE CODE REQUEST FACILITATION METHOD AND APPARATUS.

### Obtaining Information on Which Nodes Contain Which Code:

Each node 101 within communication system 100, maintains in a local memory 209 comprising a list of application code associated with its potential hosters (i.e., nodes having access to the code). Potential hosters include nodes that have requested for the code, or responded to the requests of the code. Such information is gathered by receiver 205 overhearing traffic. For example, if a node overhears that node A requests code X, which is responded by node B. Node N keeps a record <X, {A, B}> in its local memory. Afterwards, if Node N overhears that another node C requests for the same code X, for which node D responds. Node N may either choose to append the {C, D} into the existing record, or replace {A, B} with {C, D}. A Time-to-Live (TTL) for each record may be kept, and records may be deleted periodically. Also, in case hop counts from the requester and responder are visible and recorded in the history, this replacement decision can be influenced by both the hop counts in the new/old records as well as the staleness of the existing record.

In one embodiment of the present invention, information may be stored in memory 209 as an Application Call Graph (ACG) representing calling relationship among applications. ACGs also correspond with a Directed Acyclic Graph (DAG), which is an ordered pair G:=(V,E) with V is a set, whose element is vertex. A vertex indicates an application. E is also a set, whose element is directed edge where an edge e=(x,y) is considered as there is a call site in application x that resolves to a call for application y. In this relation, x is a predecessor of y, and y is a successor of x. An uppermost place of an ACG is an application from which subsequent applications are derived. It is referred to as main. The main does not have incoming edge from another application (i.e. in-degree is 0).

### Operation of Node 101:

When logic circuitry 202 needs to execute code, logic circuitry 202 accesses memory 209 and looks for the corresponding code. If the code does not exist, logic circuitry 202 accesses memory 209 and determines if there exists at least one node that may have access to the code. Node 101 utilizes transmitter 204 to send a request to the potential hosters of the code via a unicast or multicast-based method. If these hosters still have the code, they will respond by transferring the code to node N. Otherwise, logic circuitry 202 instructs transmitter 204 to send a broadcast-based request to its neighbors requesting the code.

Note that during the transmission of a request, a multi-hop path may be involved. When nodes along the path relay the requests, they can respond to the request if they have the corresponding code. Also, nodes close to the path that overhear the request can also respond to the request if they have the corresponding code. Thus, this scheme can leverage the dynamics in the network that is not visible from the requesting node.

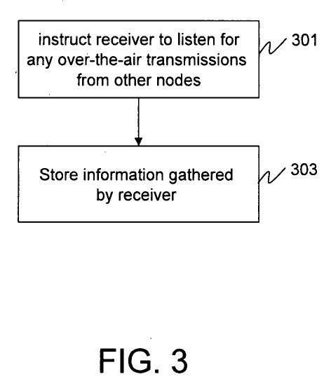

FIG. 3 is a logic flow diagram showing operation of the node of FIG. 2 while storing information about nodes. More particularly, the logic flow of FIG. 3 shows those steps necessary to gather information as to which nodes have a high probability of having particular code by listening for any over-the-air transmissions from other nodes requesting particular code or responding to a request for particular code, and then storing the information gathered.

The logic flow begins at step 301 where logic circuitry 202 instructs receiver 205 to listen for any over-the-air transmissions from other nodes. As discussed above, such transmissions may include a request for particular code, a response to a request for code, and/or any application dependencies that exist (e.g., the “owner” of code A may have a high probability of also owning code B). At step 303, logic circuitry stores information gathered by receiver 205. For example, if a node overhears that node A requests code X, which is responded by node B. Node N keeps a record <X, {A, B}> in its local memory. Afterwards, if Node N overhears that another node C requests for the same code X, for which node D responds. Node N may either choose to append the {C, D} into the existing record, or replace {A, B} with {C, D}.

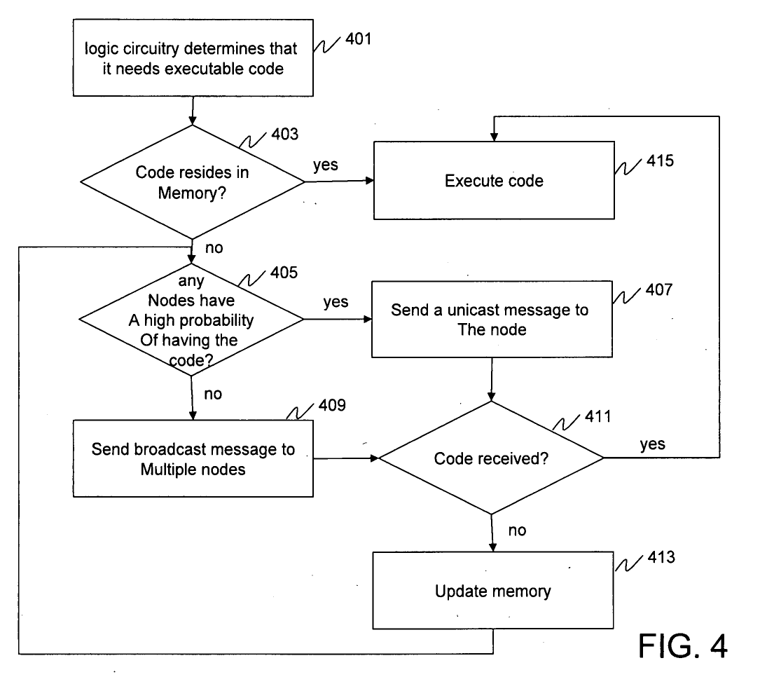

FIG. 4 is a flow chart showing operation of the node of FIG. 2 for provisioning a node with executable code. The logic flow begins at step 401 where logic circuitry 202 determines that it needs executable code. At step 403, logic circuitry 202 accesses memory 209 to determine if the needed code resides in memory 209. If the needed code resides in memory 209, the logic flow continues to step 415 where the code is executed by logic circuitry 202. However, if at step 403, logic circuitry 202 determines that the needed code is not in memory 209, the logic flow continues to step 405 where logic circuitry 202 determines if any nodes (at least one) have a high probability of having the needed code. As discussed above, a node having the high probability of having the code comprises a node that has has responded to a request for a previous version of the code, a node that has responded to a request for a related code, (where the related code is known by a dependency in an Application Call Graph or by a dependency within an application).

If, at step 405 it is determined that a node has a high probability of having the needed code, the logic flow continues to step 407 where logic circuitry 202 requests transmitter 204 to transmit a wireless unicast message to the node, otherwise, the logic flow continues to step 409 where logic circuitry 202 requests transmitter 204 to transmit a wireless broadcast message to multiple nodes (flooded) requesting the needed code.

At step 411 logic circuitry 202 determines if receiver 205 received the needed code, and if not, the logic circuitry continues to step 413 where information is memory 209 is updated by logic circuitry 202, and the logic flow returns to step 405. At step 413, memory 209 is updated to reflect the fact that particular code was requested from a particular node, and that the particular node did not have the code. Thus, at step 413, logic circuitry 202 removes any association between the requested code and the particular node. If, however, at step 411 it is determined that the needed code was received, the logic flow continues to step 415 where the code is stored and executed.

While the invention has been particularly shown and described with reference to a particular embodiment, it will be understood by those skilled in the art that various changes in form and details may be made therein without departing from the spirit and scope of the invention. For example, an extension to help speculate the potential hosters is through application dependency. An application may be required to install by being called in the middle of the execution of another application. As an illustration, assume one of two applications (B and C) is called depending on the conditional statement in A. If condition is true, application B is required, otherwise, application C is required. Through this kind of procedure, new applications are required and installed.

When a new application is required to be installed, a node first checks local records of the new application. If there is at least one record for the application, the node sends requests to the potential hosters as described above. Otherwise, the node checks its local records for information of the application that invokes the new application. If at least one record exists, the node sends request of the new application to the hosters of the invoking application. Otherwise, the request is sent using a broadcast-based method.

1. A method for provisioning a node with executable code, the method comprising the steps of:
determining if the executable code resides in memory;
determining a node having a high probability of having the code; and
transmitting a wireless unicast message to the node having the high probability of having the code, wherein the wireless unicast message requests the code from the nodes; and
receiving the executable code from the node.

2. The method of claim 1 further comprising the steps of:
gathering information as to which nodes have a high probability of having particular code by listening for any over-the-air transmissions from other nodes requesting particular code or responding to a request for particular code; and
storing the information gathered.

3. The method of claim 1 wherein the node having the high probability of having the code comprises a node that has requested the code or has responded to a request for the code.

4. The method of claim 1 wherein the node having the high probability of having the code comprises a node that has responded to a request for a previous version of the code.

5. The method of claim 1 wherein the node having the high probability of having the code comprises a node that has responded to a request for a related code.

6. The method of claim 5 wherein the related code is known by a dependency in an Application Call Graph.

7. The method of claim 5 wherein the related code is known by a dependency within an application.

8. A method for provisioning a node with executable code, the method comprising the steps of:
determining that executable code does not reside in a local memory;
determining at least one node having a high probability of having the code;
transmitting a wireless unicast message to the at least one node having the high probability of having the code, wherein the wireless unicast message requests the code from the nodes;
determining if the executable code has been received from the at least one node; and
if the executable code has not been received, then transmitting a broadcast message requesting the executable code.

9. The method of claim 8 further comprising the steps of:
gathering information as to which nodes have a high probability of having particular code by listening for any over-the-air transmissions from other nodes requesting particular code or responding to a request for particular code; and
storing the information gathered.

10. The method of claim 8 wherein the node having the high probability of having the code comprises a node that has requested the code or has responded to a request for the code.

11. The method of claim 8 wherein the node having the high probability of having the code comprises a node that has responded to a request for a previous version of the code.

12. The method of claim 8 wherein the node having the high probability of having the code comprises a node that has responded to a request for a related code.

13. The method of claim 12 wherein the related code is known by a dependency in an Application Call Graph.

14. The method of claim 12 wherein the related code is known by a dependency within an application.

15. An apparatus comprising:
memory storing information as to which nodes have a high probability of having particular code;
logic circuitry determining if the executable code resides in memory and accessing the memory to determine a node having a high probability of having the code; and
a transmitter transmitting a wireless unicast message to the node having the high probability of having the code, wherein the wireless unicast message requests the code from the nodes.

16. The apparatus of claim 11 further comprising:
a receiver gathering information as to which nodes have a high probability of having particular code by listening for any over-the-air transmissions from other nodes requesting particular code or responding to a request for particular code.

17. The apparatus of claim 11 wherein the node having the high probability of having the code comprises a node that has requested the code or has responded to a request for the code.

18. The apparatus of claim 11 wherein the node having the high probability of having the code comprises a node that has responded to a request for a previous version of the code.

19. The apparatus of claim 11 wherein the node having the high probability of having the code comprises a node that has responded to a request for a related code.

20. The apparatus of claim 19 wherein the related code is known by a dependency in an Application Call Graph.
